(19) United States
(12) Patent Application Publication
(10) Pub. No.: US 2012/0275971 A1
(43) Pub. Date: Nov. 1, 2012

(54) MICROCHIP

(75) Inventor: Shun Momose, Kyoto (JP)

(73) Assignee: ROHM CO., LTD., Kyoto (JP)

(21) Appl. No.: 13/455,399

(22) Filed: Apr. 25, 2012

(30) Foreign Application Priority Data
Apr. 26, 2011 (JP) 2011-98227

(51) Int. Cl. B01L 3/00

(52) U.S. Cl. 422/502

(57) ABSTRACT

A microchip includes a fluid circuit defined by a space formed in the microchip. A liquid present in the fluid circuit is moved to a desired position in the fluid circuit. The fluid circuit includes a first channel passing the liquid and a second channel passing the liquid passed through the first channel, and the first channel is arranged such that a first end corresponding to an end of the second channel is spaced apart from an inner wall of the second channel.

### CROSS-REFERENCE TO RELATED APPLICATION

This application is based upon and claims the benefit of priority from Japanese Patent Application No. 2011-98227, filed on Apr. 26, 2011, the entire contents of which are incorporated herein by reference.

### TECHNICAL FIELD

The present disclosure relates to a microchip which contains a fluid circuit and is capable of examination and analysis. A specimen, such as a reagent, present in the fluid circuit is moved to a desired position within the fluid circuit by application of a centrifugal force.

### BACKGROUND

In recent years, as sensing, detection and quantization of biomaterials such as DNAs (Deoxyribo Nucleic Acids), enzymes, antigens, antibodies, proteins, viruses and cells, and chemical substances in the fields of medicine, health, food, abscess drug, etc., become increasingly important, there have been proposed a variety of biochips and micro chemical chips (hereinafter collectively referred to as “microchips”) which can measure these biomaterials and chemical substances in a simple manner.

A microchip provides many advantages in that a series of analytic and experimental operations in laboratories can be carried out in a chip having a surface are of several square centimeters and a thickness of several millimeters to one centimeter. Thus, a reduced amount of specimens and reagents required for analysis and experiment can lead to low costs, high throughput due to fast reaction and direct acquisition of results of examination in the field where the specimens are collected, etc. Such a microchip is suitable to be used for biochemical examination such as blood tests.

A conventional microchip includes a channel network (also called a fluid circuit or a micro fluid circuit) including a plurality of parts (chambers) for subjecting a liquid such as a specimen, a reagent, etc., present in the circuit to a specific treatment, and minute channels which properly interconnect these parts. For examination or analysis of the specimen using the microchip containing such a fluid circuit, the fluid circuit is used to perform various treatments. The treatments include measuring the specimen introduced into the fluid circuit and the reagent to be mixed with the specimen (that is, moving them to a measurement unit which is used for measurement), mixing the specimen and the reagent (that is, moving them to a mixer which is used for mixing), moving them from one part to another, etc. A treatment performed for various kinds of liquids (a specimen, a particular ingredient in the specimen, a liquid reagent, a mixture of at least two of them, etc.) in the microchip is hereinafter referred to as a “fluid treatment.” These fluid treatments may be performed by applying different centrifugal forces to the microchip in different proper directions.

In the microchip for performing the fluid treatments by moving the liquids in the fluid circuit to a desired position (region) in the fluid circuit using the centrifugal forces, if wettability of the liquids is relatively high, there has been a problem that unintended liquid movement occurred along an inner wall of the fluid circuit due to surface tension. For example, irrespective of no application of a centrifugal force, there has been a case where a liquid reagent leaks along the fluid circuit inner wall out of a reagent container which accommodates the liquid reagent.

Further, a microchip having a valve has been proposed to prevent discharge of liquid. However, this valve needs to be further improved since it has a relatively complicated structure.

### SUMMARY

The present disclosure provides some embodiments of a microchip which are capable of moving a liquid present in a fluid circuit to a desired position within the fluid circuit by application of a centrifugal force, thereby preventing unintended movement of the liquid due to surface tension.

According to one aspect of the present disclosure, there is provided a microchip which includes a fluid circuit defined by a space formed in the microchip. A liquid present in the fluid circuit is moved to a desired position in the fluid circuit. The fluid circuit includes a first channel passing the liquid and a second channel passing the liquid passed through the first channel With this configuration, the first channel is arranged such that a first end thereof is at an end of the second channel and is spaced apart from an inner wall of the second channel.

In one example, the fluid circuit may include a reagent container which accommodates a liquid reagent, and the reagent container has a discharge hole for discharging the liquid reagent in the first end out of the reagent container.

In another example, the first end of the first channel may be arranged to be located within the second channel. In still another example, a sectional area of the first channel is smaller than a sectional area of the second channel.

### BRIEF DESCRIPTION OF THE DRAWINGS

Embodiments of the inventive aspects of this disclosure will be understood with reference to the following detailed description, when read in conjunction with the accompanying drawings, in which:

FIGS. 1A and 1B are a perspective view and a sectional view conceptually illustrating a first channel and a second channel of a fluid circuit of a microchip according to the present disclosure.

FIGS. 2A and 2B are sectional views schematically illustrating a reagent container and its vicinity in the microchip according to the present disclosure, and a state of movement of a liquid reagent accommodated in the reagent container.

FIGS. 3A and 3B are sectional views schematically illustrating a reagent container and its vicinity in a conventional microchip, and a state of movement of a liquid reagent accommodated in the reagent container, and FIG. 3C is a perspective view of a portion A in FIG. 3A.

FIGS. 4A to 4C are views illustrating an example of the external appearance of the microchip of the present disclosure.

FIG. 5 is a top view illustrating a second substrate constituting the microchip shown in FIGS. 4A to 4C.

FIG. 6 is a bottom view illustrating the second substrate constituting the microchip shown in FIGS. 4A to 4C.

FIGS. 7A to 7C are a top view, a sectional view and a bottom view illustrating a structure of the reagent container and its vicinity in the microchip shown in FIGS. 4A to 4C, respectively.

FIGS. 8A to 8C are a top view, a sectional view and a bottom view illustrating a structure of the reagent container and its vicinity in the conventional microchip, respectively.

FIGS. 9A and 9B are views illustrating states of liquid of the top of the second substrate (a surface thereof adjacent to a first substrate) and liquid of the bottom of the second substrate (a surface thereof adjacent to a third substrate) in a process of measurement of whole blood and reagent in fluid treatment using the microchip shown in FIGS. 4A to 4C, respectively.

FIGS. 10A and 10B are views illustrating states of liquid of the top of the second substrate (a surface thereof adjacent to a first substrate) and liquid of the bottom of the second substrate (a surface thereof adjacent to a third substrate) in a process of movement of whole blood in fluid treatment using the microchip shown in FIGS. 4A to 4C, respectively.

FIGS. 11A and 11B are views illustrating states of liquid of the top of the second substrate (a surface thereof adjacent to a first substrate) and liquid of the bottom of the second substrate (a surface thereof adjacent to a third substrate) in a process of separation of blood cell in fluid treatment using the microchip shown in FIGS. 4A to 4C, respectively.

FIGS. 12A and 12B are views illustrating states of liquid of the top of the second substrate (a surface thereof adjacent to a first substrate) and liquid of the bottom of the second substrate (a surface thereof adjacent to a third substrate) in a process of measurement of plasma ingredient in fluid treatment using the microchip shown in FIGS. 4A to 4C, respectively.

FIGS. 13A and 13B are views illustrating states of liquid of the top of the second substrate (a surface thereof adjacent to a first substrate) and liquid of the bottom of the second substrate (a surface thereof adjacent to a third substrate) in a first step of a first mixing process in fluid treatment using the microchip shown in FIGS. 4A to 4C, respectively.

FIGS. 14A and 14B are views illustrating states of liquid of the top of the second substrate (a surface thereof adjacent to a first substrate) and liquid of the bottom of the second substrate (a surface thereof adjacent to a third substrate) in a second step of the first mixing process in fluid treatment using the microchip shown in FIGS. 4A to 4C, respectively.

FIGS. 15A and 15B are views illustrating states of liquid of the top of the second substrate (a surface thereof adjacent to a first substrate) and liquid of the bottom of the second substrate (a surface thereof adjacent to a third substrate) in a first step of a second mixing process in fluid treatment using the microchip shown in FIGS. 4A to 4C, respectively.

FIGS. 16A and 16B are views illustrating states of liquid of the top of the second substrate (a surface thereof adjacent to a first substrate) and liquid of the bottom of the second substrate (a surface thereof adjacent to a third substrate) in a second step of the second mixing process in fluid treatment using the microchip shown in FIGS. 4A to 4C, respectively.

FIGS. 17A and 17B are views illustrating states of liquid of the top of the second substrate (a surface thereof adjacent to a first substrate) and liquid of the bottom of the second substrate (a surface thereof adjacent to a third substrate) in a detector introducing process in fluid treatment using the microchip shown in FIGS. 4A to 4C, respectively.

FIG. 18 is a graph illustrating results of a test for liquid reagent retentivity.

FIG. 19 is a top view illustrating another example of the microchip of the present disclosure.

FIG. 20 is a sectional view schematically illustrating a structure of reagent container and its vicinity in the microchip shown in FIG. 19.

FIG. 21 is a sectional view schematically illustrating still another example of the microchip of the present disclosure.

FIG. 22 is a sectional view schematically illustrating still another example of the microchip of the present disclosure.

FIGS. 23A and 23B are a sectional view and is a perspective view schematically illustrating still another example of the microchip of the present disclosure illustrating a state of plasma ingredient in a process of introduction of plasma in fluid treatment using the microchip.

FIGS. 24A and 24B are views illustrating a state of plasma ingredient in a process of measurement of plasma in fluid treatment using the microchip shown in FIGS. 23A and 23B.

FIGS. 25A and 25B are views illustrating a state of plasma ingredient in a process of discharge of plasma in fluid treatment using the microchip shown in FIGS. 23A and 23B.

### DETAILED DESCRIPTION

Reference will now be made in detail to various embodiments, examples of which are illustrated in the accompanying drawings. In the following detailed description, numerous specific details are set forth in order to provide a thorough understanding of the inventive aspects of this disclosure. However, it will be apparent to one of ordinary skill in the art that the inventive aspects of this disclosure may be practiced without these specific details. In other instances, well-known methods, procedures, systems, and components have not been described in detail so as not to unnecessarily obscure aspects of various embodiments.

A microchip of the present disclosure is a chip capable of various chemical syntheses, examinations, analyses, etc., using an internal fluid circuit. For example, the microchip may have a stacked structure including a first substrate and a second substrate which is stacked on the first substrate and has grooves formed on the surface thereof. In this case, the fluid circuit of the microchip is an internal space formed by the grooves and a surface of the first substrate.

In addition, the microchip of the present disclosure may include a first substrate, a second substrate which is stacked on the first substrate and has grooves formed on both surfaces thereof, and a third substrate stacked on the second substrate. In this case, a fluid circuit has a two-layered structure including a first fluid circuit and a second fluid circuit. The first fluid circuit is defined by a space formed in a surface of the second substrate adjacent to the first substrate and grooves formed on a surface of the first substrate adjacent to the second substrate. The second fluid circuit is defined by a space formed in a surface of the third substrate adjacent to the first substrate and grooves formed on a surface of the first substrate adjacent to the third substrate. As used herein, the term “two-layered” means that fluid circuits are placed at two different positions with respect to the thickness direction of the microchip. Such two-layered fluid circuits may be interconnected through a through hole penetrating through the first substrate in the thickness direction.

The size of the microchip is not particularly limited. For example, the microchip may have a surface area of several to 10 square centimeters and may have a thickness of several millimeters to several centimeters.

A method of bonding substrates is not particularly limited. For example, a bonding surface of at least one of substrates to be bonded may be melted and welded (welding method) or may be bonded using an adhesive. The welding method may include a method of heating and welding a substrate, a method of welding a substrate using heat generated in light absorption with irradiation of light such as laser light (laser welding), a method of welding a substrate using an ultrasonic wave, etc. Among these, the laser welding may be chosen to be used in advance.

Material of the substrates constituting the microchip of the present disclosure is not particularly limited. For example, examples of the material may include organic material and in organic material. The organic material may include thermoplastic resin such as polyethyleneterephthalate (PET), polyethylenenaphthalate (PEN), polybutyleneterephtalate (PBT), polymethylmetacrylate (PMMA), polycarbonate (PC), polystyrene (PS), polypropylene (PP), polyethylene (PE), polyarylate resin (PAR), acrylonitrile-butadiene-styrene resin (ABS), styrene-butadiene resin (styrene-butadiene copolymer), vinyl chloride resin (PVC), polymethylpentene resin (PMP), polybutadiene resin (PBD), biodegradable polymer (BP), cycloolefm polymer (COP), polydimethyl siloxane (PDMS), polyacetal (POM), polyamide (PA), etc. The inorganic material may include silicone, glass, quartz, etc. Among these, the thermoplastic resin may be used in consideration of formability of the fluid circuit.

If the microchip includes the first substrate and the second substrate having grooves formed on the surface thereof, the second substrate may be a transparent substrate in that it typically includes a part irradiated with detection light for optical measurement. The first substrate may be either a transparent substrate or an opaque substrate. If laser welding is performed, the opaque substrate may be used since light absorbance can be increased. In addition, the substrate may be formed of thermo-plastic resin and it may be made of a black substrate which may be obtained by adding a black pigment such as carbon black, etc., to thermoplastic resin.

If the microchip includes the first substrate, the second substrate having grooves formed on both surfaces thereof, and the third substrate, the second substrate may be an opaque substrate from the standpoint of efficiency of laser welding and a black substrate may be more appropriate for the second substrate. On the other hand, each of the first and third substrates may become a transparent substrate for the purpose of construction of a detector. If each of the first and third substrates is the transparent substrate, a detector (a cuvette for optical measurement) can be formed by a through hole formed in the second substrate and the transparent first and third substrates. Further, it becomes possible to perform optical measurements such as detecting the intensity of transmitting light (transmittance) by irradiating the detector with light in a direction substantially perpendicular to a surface of the microchip.

A method of forming grooves (pattern grooves) constituting a fluid circuit on the surface of the second substrate is not particularly limited. The method of forming such grooves may include an injection molding method using a mold with a transferring structure, an imprinting method, etc. An etching method or the like may be used to form substrates, if inorganic material is used. The shape (pattern) of the grooves is determined to provide a desired proper fluid circuit structure.

The microchip of the present disclosure can subject a liquid (a specimen, a specific ingredient in the specimen, a liquid reagent, a mixture of at least two of them, etc) in a fluid circuit to a proper fluid treatment by moving the liquid to a desired position (part) in the fluid circuit under the application of a centrifugal force. To this end, the fluid circuit includes a variety of parts (chambers) which are arranged at proper positions and are appropriately interconnected via minute channels.

The fluid circuit may include, as the above mentioned variety of parts (chambers), a reagent container, a separator, a specimen measurement unit, a reagent measurement unit, a mixer, a detector, etc. The reagent container is configured to accommodate a liquid reagent to be mixed with (or to react with) a specimen to be examined or analyzed. The separator is configured to extract a particular ingredient from the specimen introduced into the fluid circuit. The specimen measurement unit is configured to measure the specimen (including the particular ingredient in the specimen, the same as above). The reagent measurement unit is configured to measure the liquid reagent. The mixer is configured to mix the specimen and the liquid reagent. The detector (a cuvette for optical measurement) is configured to examine or analyze a resultant mixed solution (for example, detecting or quantifying a particular ingredient in the mixed solution). A method for examination or analysis is not particularly limited. The method for examination or analysis may include optical measurements including a method for detecting the intensity of transmitting light (transmittance) with irradiation of the detector receiving the mixed solution with light, a method for measuring an absorption spectrum for the mixed solution retained in the detector. The microchip of the present disclosure may have all or some of the above-mentioned parts or have parts other than the above-mentioned parts.

As used herein, the term “specimen” refers to a substance to be examined or analyzed by the microchip, such as, for example, whole blood. As used herein, the term “liquid reagent” refers to a reagent which is used to treat the specimen to be examined or analyzed by the microchip, or is mixed or reacts with the specimen and is typically contained in the reagent container of the fluid circuit before the microchip is used.

Various fluid treatments in the fluid circuit, such as extraction of the particular ingredient from the specimen (separation of unnecessary ingredients from the specimen), measurement of the specimen and/or the reagent, mix of the specimen and the reagent, introduction of the acquired mixed solution into the detector, etc., may be performed by sequentially applying different centrifugal forces to the microchip in proper directions. The centrifugal forces may be applied to the microchip using an apparatus capable of applying a centrifugal force (a centrifugal apparatus) on which the microchip is mounted. The centrifugal apparatus may include a rotatable rotor (or a rotator) and a rotatable stage disposed on the rotor. The centrifugal forces may be applied to the microchip in any different directions by arbitrarily setting an angle of the microchip with respect to the rotor rotating the stage on which the microchip is mounted.

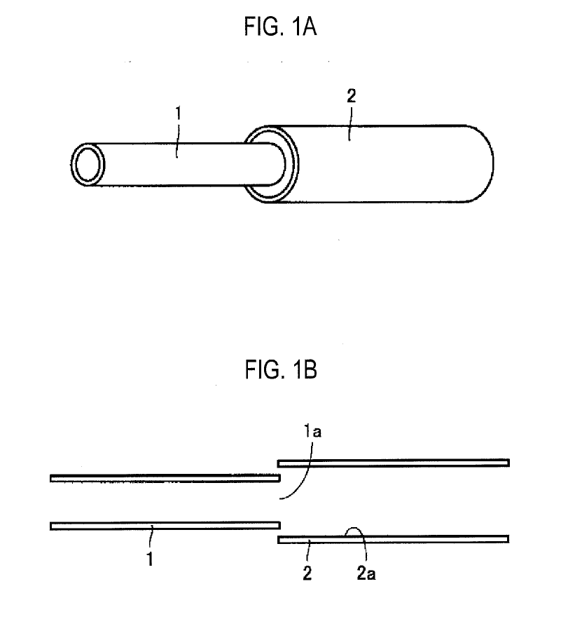

As conceptually illustrated in FIGS. 1A and 1B, in the microchip of the present disclosure, the fluid circuit includes a first channel 1 passing the liquid and a second channel 2 passing the liquid passed the first channel 1. A first end 1a of the first channel 1 at an end of the second channel 2 is spaced apart from (i.e., making no contact with) an inner wall 2a of the second channel 2. The first and second channels 1 and 2 may be channels interconnecting the above-described parts (chambers) constituting the fluid circuit, or may be the parts (chambers) themselves or a portion thereof. FIG. 1A is a perspective view conceptually illustrating the first channel 1 and the second channel 2 of the fluid circuit of the microchip according to the present disclosure and FIG. 1B is a sectional view thereof.

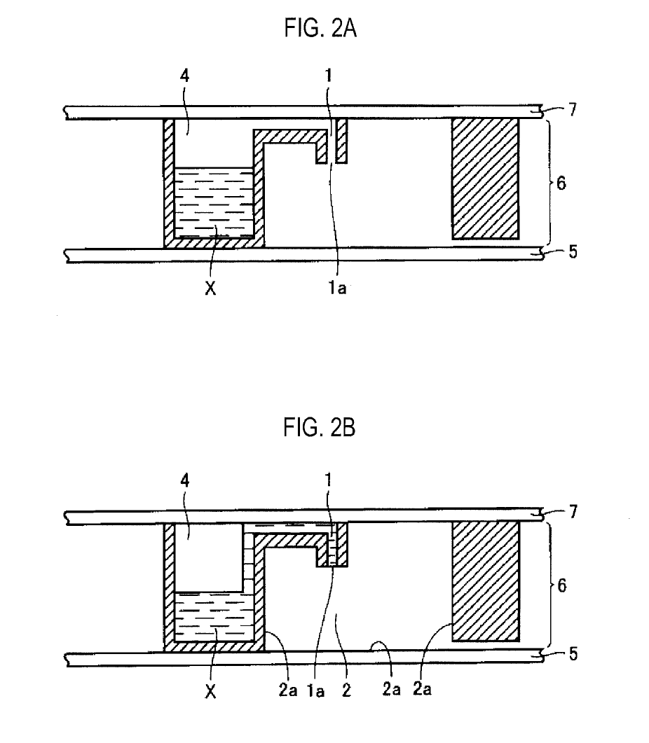

According to the microchip having the above-described characteristics, it is possible to effectively prevent unintended movement of the liquid due to surface tension from the first end 1a of the first channel 1. This advantageous effect will be illustrated in more detail with a case where the first end 1a corresponds to a discharge hole for discharging a liquid reagent from a reagent container. FIGS. 2A and 2B are sectional views schematically illustrating a reagent container and its vicinity in the microchip according to the present disclosure, and a state of movement of a liquid reagent accommodated in the reagent container. The microchip shown in FIGS. 2A and 2B has a stacked structure including a first substrate 7, a second substrate 6 and a third substrate 5. A reagent container 4 for accommodating a liquid regent X is faulted by a groove formed on a surface of the second substrate 6 and the first substrate 7 (see FIG. 2A).

In addition, in the microchip shown in FIGS. 2A and 2B, the end (such as the first end la which corresponds to the discharging hole of the liquid reagent X) of the first channel 1 extending from the reagent container 4 is spaced apart from (makes no contact with) the inner wall 2a of the second channel 2 through which the liquid reagent X passes through the first channel 1 (see FIG. 2A). Accordingly, the liquid reagent X reaches the first end la and is accommodated without leaking into the second channel 2, thereby preventing unintended movement of the liquid reagent X to the second channel 2 (see FIG. 2B). For intended movement of the liquid reagent X to the second channel 2, a centrifugal force is applied to the microchip.

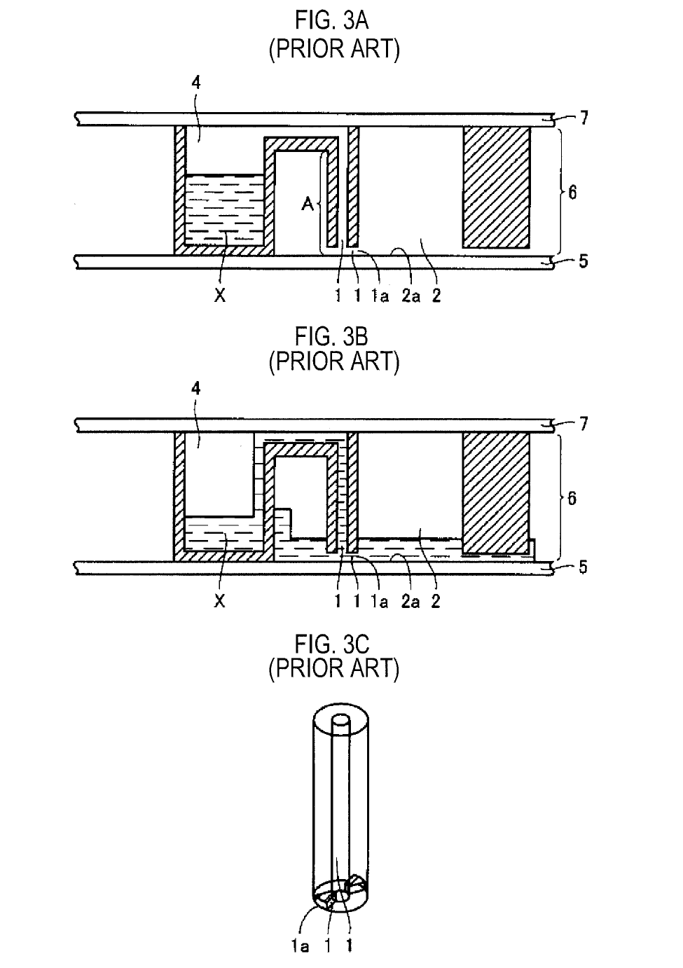

On the contrary, in a conventional microchip shown in FIGS. 3A to 3C, since the first end 1a of the first channel 1 is in contact with the inner wall 2a of the second channel 2 and the inner wall of the first channel 1 is continuously connected to the inner wall of the second channel 2 (see FIG. 3A), the liquid reagent X that reaches the first end 1a leaks into the second channel 2 due to surface tension (see FIG. 3B). FIG. 3C is a schematic perspective view of a portion A shown in FIG. 3A.

The present disclosure will be now described in more detail by way of embodiments.

### First Embodiment

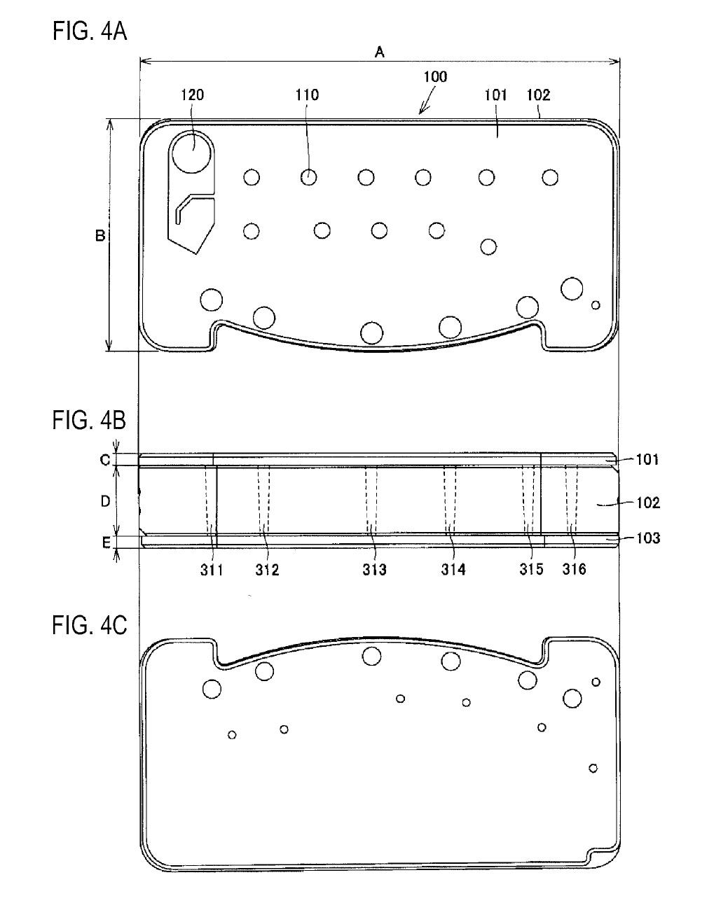

FIGS. 4A to 4C are a top view, a side view and a bottom view illustrating an example external appearance of the microchip of the present disclosure, respectively. A microchip 100 shown in FIGS. 4A to 4C includes a first substrate 101 which is a transparent substrate, a second substrate 102 which is a black substrate, and a third substrate 103 which is a transparent substrate 103, all of which are bonded together in order (see FIG. 4B). The dimensions of these substrates are not particularly limited. For example, in this embodiment, each of the substrates may be of a rectangular shape of about 62 mm (denoted by A in FIG. 4A)×about 30 mm (denoted by B in FIG. 4A). In addition, in this embodiment, thicknesses (denoted by C, D and E in FIG. 4B) of the first to third substrates 101, 102 and 103 are set to about 1.6 m, about 9 mm and about 1.6 mm, respectively. However, the size of the microchip according to this embodiment is not limited to the above-mentioned size.

The first substrate 101 is formed with a plurality of (11 in total in this embodiment) reagent introduction holes 110 and a specimen introduction hole 120 for introducing a specimen (for example, whole blood) into a fluid circuit, all of which penetrates through the first substrate 101 in its thickness direction. For practical use, the microchip 100 of this embodiment is typically offered with the reagent introduction holes 110 sealed by a sealing label, etc., after injection of a liquid reagent from the reagent introduction holes 110.

The second substrate 102 is formed with grooves formed on both sides of the substrate and a plurality of through holes penetrating through the second substrate 102 in its thickness direction. When the first and third substrates 101 and 103 are bonded to the grooves and the through holes, a two-layered fluid circuit is formed in the microchip. In the following description, a fluid circuit constituted by the first substrate 101 and grooves formed on a surface of the second substrate 102 above the first substrate 101 is referred to as a “first fluid circuit.”In addition, a fluid circuit constituted by the third substrate 103 and grooves formed on a surface of the second substrate 102 above the third substrate 103 is referred to as a “second fluid circuit.” These two fluid circuits are interconnected by the through holes which are formed in the second substrate 102 and penetrate through the second substrate 102. Configuration of the fluid circuits (grooves) formed in both sides of the second substrate 102 will be described in detail below.

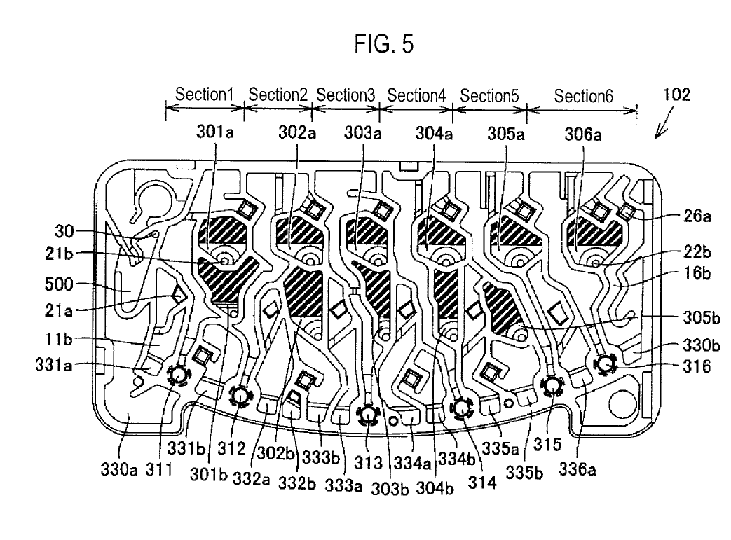

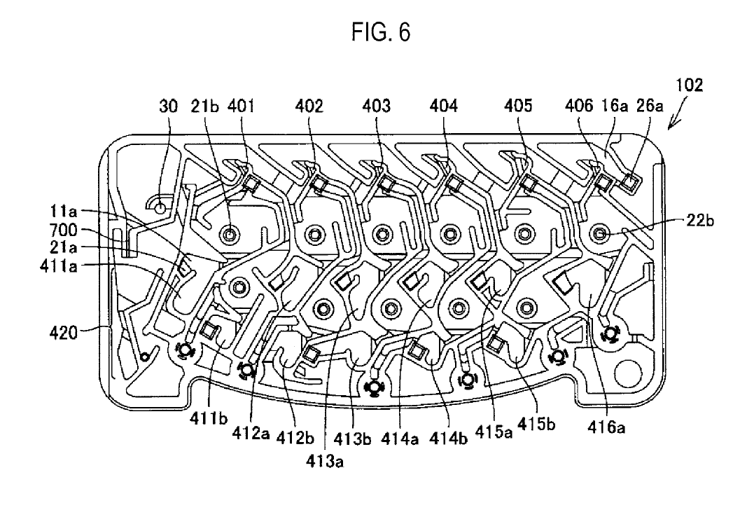

FIGS. 5 and 6 are a top view and a bottom view of the second substrate 102 in the microchip shown in FIGS. 4A to 4C. FIG. 5 illustrates an upper fluid circuit (the first fluid circuit) of the second substrate 102 and FIG. 6 illustrates a lower fluid circuit (the second fluid circuit) thereof. In addition, for the purpose of clear understanding of a correspondence relationship with the upper fluid circuit shown in FIG. 5, it is shown in FIG. 6 that the lower fluid circuit of the second substrate 102 is reversed in its left and right. The microchip 100 of this embodiment is a multi-item chip capable of examination or analysis for 6 items per one specimen. Further, each of its fluid circuits is divided into 6 sections (sections 1 to 6 in FIG. 5) to allow examination or analysis for the 6 items [where, these sections are interconnected in a displacement part of a first ingredient measurement unit (an upper part of a lower fluid circuit)].

In each of the sections, one or two reagent containers containing a liquid reagent are provided within the first fluid circuit (upper fluid circuit) (therefore there are a total of 11 reagent containers 301a, 301b, 302a, 302b, 303a, 303b, 304a, 304b, 305a, 305b and 306a in FIG. 5). If the specimen introduced from the specimen introduction hole 120 shown in FIG. 4A is measured, a blood cell ingredient thereof is separated from the specimen, and the specimen with no blood cell ingredient is distributed over the sections and is measured, the measured specimen is mixed with one or two kinds of separately measured liquid reagents within each of the sections and then is introduced into each of detectors 311, 312, 313, 314, 315 and 316. The mixed solution introduced into each detector of each section is subjected to optical measurement, such as irradiating the detector with light in a direction substantially perpendicular to the surface of the microchip and measuring a transmittance of transmitted light, in order to detect a particular ingredient in the mixed solution. Such a series of fluid treatment is performed by moving the liquid reagent, the specimen, a particular ingredient in the specimen or a mixed solution of the particular ingredient and the liquid reagent to each part within the two-layered fluid circuit formed in each section in proper order by applying centrifugal forces corresponding to the microchip in proper directions. Such application of the centrifugal forces to the microchip may be performed, for example by the above-described centrifugal apparatus mounted with the microchip.

Each reagent container is connected to the respective reagent measurement unit through the respective channel (through-hole) penetrating through the second substrate 102. For example, the reagent container 301a (see FIG. 5) of the section 1 is connected to a reagent measurement unit 411a (see FIG. 6) through a channel 21b. This may be equally applied to other reagent containers and reagent measurement units.

In each of the sections, ingredient measurement units (a total of 6 specimen measurement units 401, 402, 403, 404, 405 and 406 in FIG. 6) for measuring a particular ingredient (for example, a plasma ingredient) separated from the specimen and reagent measurement units (totally 11 reagent measurement units 411a, 411b, 412a, 412b, 413a, 413b, 414a, 414b, 415a, 415b and 416a in FIG. 6) for measuring a liquid reagent are provided within the second fluid circuit (lower fluid circuit). These specimen measurement units are connected in series by channels (see FIG. 6).

The microchip 100 includes a specimen measurement unit 500 (see FIG. 5) for measuring a specimen introduced into the microchip, a flow rate restrictor 700 (see FIG. 6) and a separator 420 (see FIG. 6) for separating an unnecessary ingredient from the measured specimen and extracting a particular ingredient (an ingredient to be mixed with the liquid reagent). The extraction of the particular ingredient is achieved by centrifugal separation. The specimen measurement unit 500 is connected to the flow rate restrictor 700 through a channel (through-hole) 30.

In addition, as shown in FIG. 5, the microchip 100 includes spillage containers 330a and 330b for accommodating a specimen or particular ingredient spilled over out of the specimen measurement unit and the ingredient measurement unit in the measurement and spillage reagent containers 331a, 331b, 332a, 332b, 333a, 333b, 334a, 334b, 335a, 335b and 336a for accommodating a liquid reagent spilled over out of the reagent measurement unit in the measurement. The spillage container 330b is connected to the ingredient measurement unit 406 through a channel 16a (see FIG. 6) and channels (through-holes) 26a and 16b (see FIG. 5) penetrating through the second substrate 102 in its thickness direction. In addition, each spillage reagent container is connected to the respective reagent measurement unit through the respective channel. For example, in section 1, the reagent measurement unit 411a for measuring the liquid reagent accommodated in the reagent container 301a and the spillage reagent container 331a for accommodating a spillage liquid reagent (see FIG. 3) are interconnected through a channel 11a (see FIG. 6) and channels (through-holes) 21a and 11b (see FIG. 5) penetrating through the second substrate 102 in its thickness direction. This may be equally applied to other spillage reagent containers.

In this manner, as the microchip includes the spillage containers and the spillage reagent containers (hereinafter sometimes collectively referred to as an spillage container), by detecting the presence of a spillage of solution and reagent in the spillage container, it can be easily confirmed whether or not a specimen, a particular ingredient or a liquid reagent is reliably transferred to a measurement unit by a centrifugal operation and the measurement unit is filled with a substance to be measured. That is, if the presence of the spillage of solution and reagent is detected, it is ensured that the specimen, the particular ingredient or the liquid reagent is correctly measured in the measurement unit.

As one example of a method of detecting the presence of the spillage of solution and reagent in the spillage container, a method of irradiating the microchip with light from one end of the first transparent substrate 101 and measuring intensity of reflected light may be used. The light used is not particularly limited but may be, for example, monochromatic light (for example, laser light) having a wavelength of 400 to 1000 nm or mixed light such as white light. The measurement of the intensity of the reflected light may be made using, for example, an available reflecting sensor, etc.

The basic operation in the method of detecting the presence of the spillage of solution and reagent by measuring the intensity of the reflected light includes obtaining a ratio of intensity of reflected light and then detecting the presence of the spillage substance based on the obtained intensity ratio. The ratio of intensity of reflected light is obtained from a comparison between the intensity of reflected light measured by irradiating the spillage container with light from the side of the first substrate 101 after a substance to be measured is introduced into the measurement unit and the intensity of reflected light measured by irradiating the spillage container with light from the side of the first substrate 101 before spillage is introduced into the spillage container. That is, if the ratio (the reflected light intensity after the introduction/the reflected light intensity before the introduction) is smaller than 1 (i.e., if the reflected light intensity after the introduction is smaller than the reflected light intensity before the introduction), then it is determined that the spillage is present in the spillage container. However, if variations between microchips are small and the reflected light intensity before the introduction of the spillage is substantially constant between the microchips, the measurement of the reflected light intensity before the introduction of the spillage may be omitted.

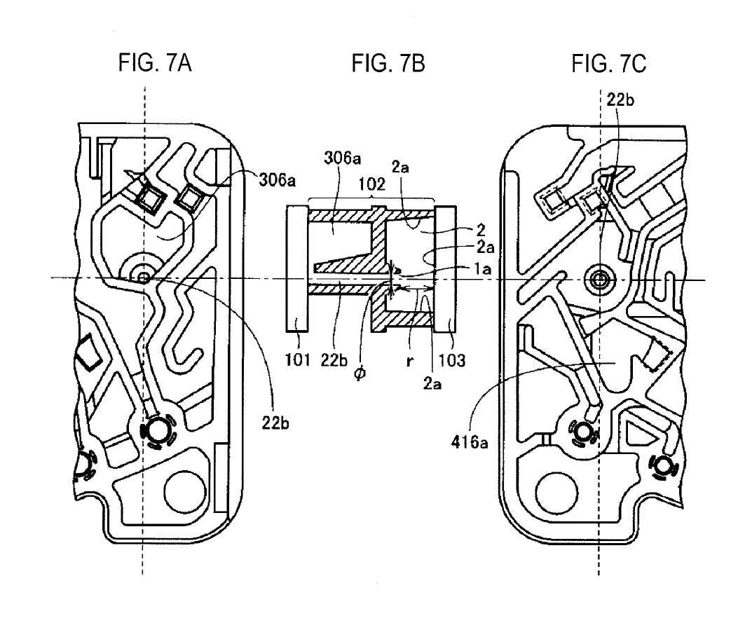

In this embodiment, the microchip 100 has the above-described characteristics for the structure of the reagent containers and other elements adjacent to them. The reagent container 306a will be described below by way of example. FIGS. 7A to 7C are a top view, a sectional view and a bottom view illustrating a structure of the reagent container and its vicinity, respectively. It is here noted that the bottom view of FIG. 7C is reversed in its left and right to that of FIG. 6. FIG. 7B is the sectional view taken along a dotted line shown in FIGS. 7A and 7B. This sectional view shows both the first and third substrates 101 and 103 with the second substrate 102 interposed therebetween.

As shown in FIGS. 7A to 7C, the reagent container 306a includes a channel (through-hole) 22b which has one end (second end) connected to the reagent container 306a and guides a liquid reagent within the reagent container 306a to the reagent measurement unit 416a. The channel 22b corresponds to the above-described first channel. Referring to FIG. 7B, the channel 22b is arranged such that its other end corresponding to the first end 1a (the discharge hole of the liquid reagent) is spaced apart from (i.e., makes no contact with) the inner wall 2a of the second channel 2. This arrangement can prevent the liquid reagent that reaches the first end 1a from leaking into the second channel 2.

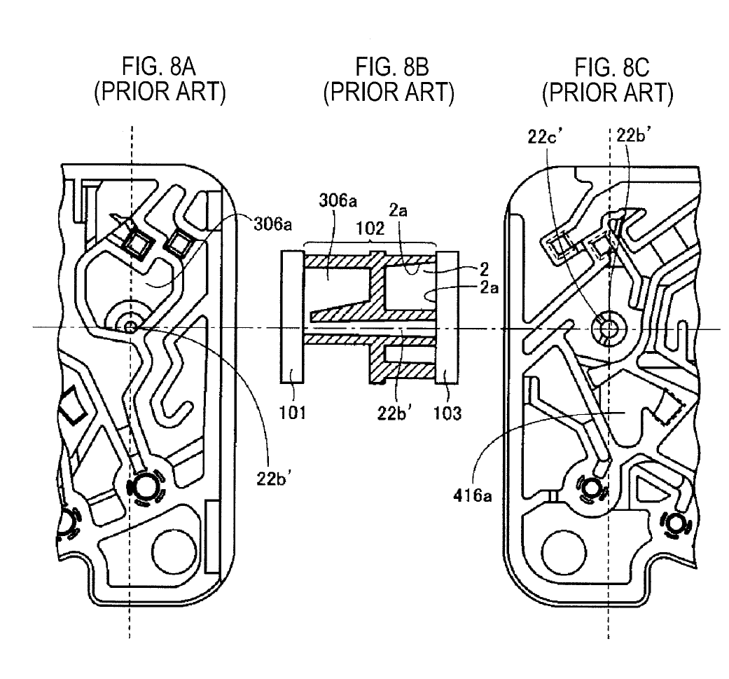

FIGS. 8A to 8C shows a structure of the reagent container and its vicinity in a conventional microchip. In the conventional microchip, since the first channel formed by a channel 22b′ and a channel 22c′ (see FIG. 8C) contacts the inner wall 2a of the second channel 2, a liquid passed through the channel 22b′ leaks into the second channel 2 through the channel 22c′ due to surface tension. Here, the channel 22b′ extends from the reagent container 306a and reaches the third substrate 103. The channel 22c′ is formed by a cutout groove provided in an end of the channel 22b′ adjacent to the third substrate 103

Referring to FIGS. 7A and 7C, assuming that an inner diameter of the first end 1a is φ and a distance from the first end la to the inner wall 2a facing the first end 1a is r, the microchip 100 of this embodiment may satisfy a relationship of r>φ/2, more specifically a relationship of r>3φ/2. According to this relationship, since the liquid reagent moving from the first end 1a will not contact the inner wall 2a facing the first end 1a, the liquid reagent will not leak into the second channel 2 because of surface tension thereby making it is possible to more reliably prevent the liquid reagent from leaking into the second channel 2.

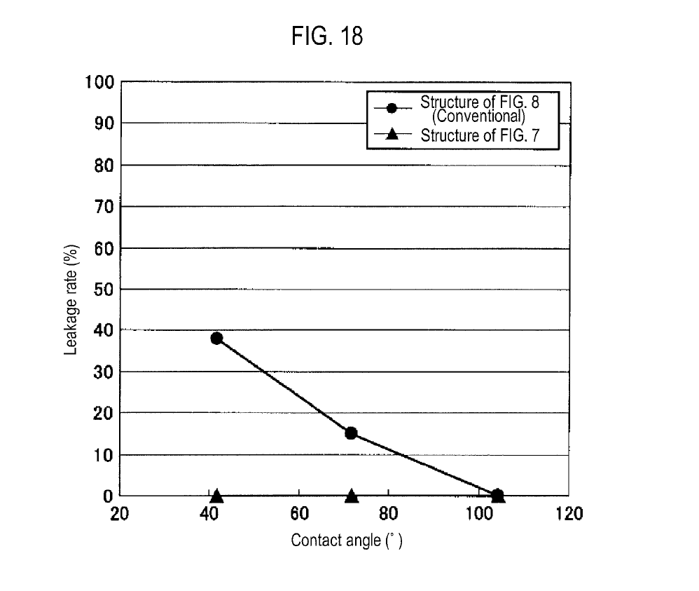

As described below, a test for liquid reagent retentivity was made as to a microchip having the same configuration as the microchip 100, as shown in FIGS. 7A and 7B, except the structure of each reagent container and its vicinity. In this microchip, the structure of each reagent container and its vicinity has the same configuration as the reagent container and its vicinity, as shown in FIGS. 8A and 8B. Results of the test are shown in a graph of FIG. 18.

A liquid reagent was put in each of the reagent containers (11 in total) of the microchip 100, reagent introduction holes were sealed, and the microchip 100 was maintained at a temperature of 4 degrees C. for 240 hours. Regarding the microchip after maintenance, the presence of leakage of the liquid reagent from a discharging hole (the first end) in each reagent container was confirmed. After the same test was repeated six times in total (n=66), a leakage rate (100×number of leaked reagent containers/66) was calculated. The liquid reagent retentivity test was made for three kinds of liquid reagents having different wettabilities (contact angles). The same test was also made for the microchip having the structure shown in FIGS. 8A to 8C.

As shown in FIG. 18, in the microchip 100 according to the present disclosure, the leakage rate was 0% even when a liquid reagent having high wettability (low contact angle) was used. In contrast, in the conventional microchip having the structure shown in FIG. 8, the leakage rate was about 40% when a liquid reagent having high wettability (contact angle of about 41°) was used.

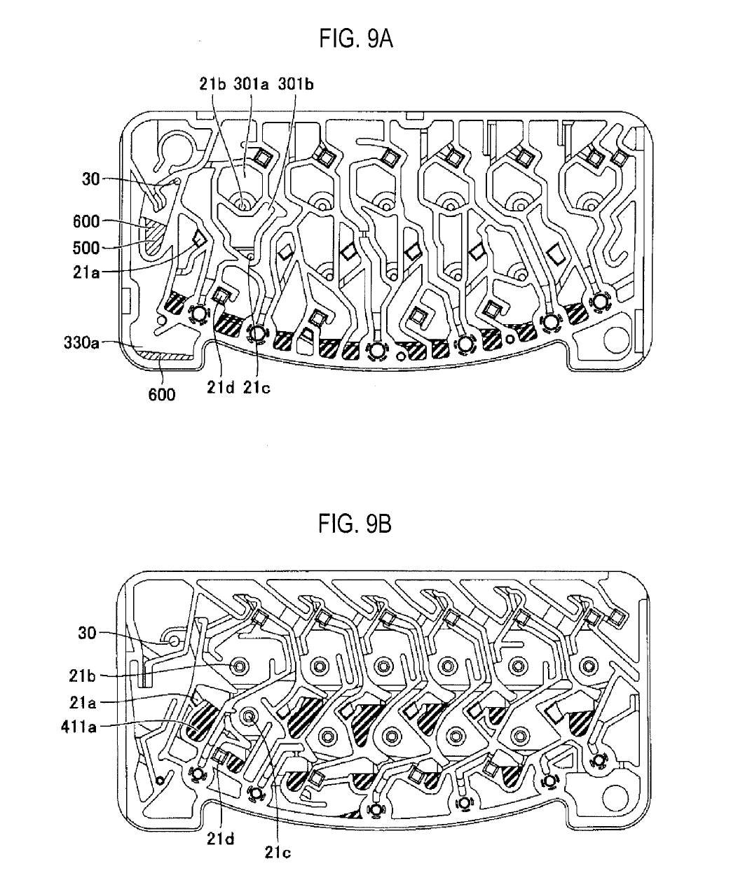

Next, an example of fluid treatment using the microchip 100 of this embodiment will be described with reference to FIGS. 9A to 17B. FIGS. 9A to 17B are views illustrating states of liquid (a specimen, a particular ingredient thereof, a liquid reagent and a mixture of the particular ingredient and the liquid reagent) of the top of the second substrate 102 (a surface thereof adjacent to the first substrate) and the liquid of the bottom of the second substrate 102 (a surface thereof adjacent to the third substrate) in each process in fluid treatment, respectively. In each figure, A is a view illustrating the state of liquid of the top (the first fluid circuit) of the second substrate and B is a view illustrating the state of liquid of the bottom (the second fluid circuit) of the second substrate. In addition, like FIG. 6A, for the purpose of clear understanding of a correspondence relationship with the upper fluid circuit shown in FIGS. 9A to 17B, it is shown in B in FIGS. 9A to 17B that the lower fluid circuit of the second substrate 102 is reversed in its left and right. In addition, although only a fluid treatment in a fluid circuit of section 1 will be illustrated in the following description, the same fluid treatment may be carried out for other sections, as can be clearly understood from the figures. In addition, although a specimen is illustrated below with whole blood, the kind of specimen is not limited thereto.

(1) Measurement Process of Whole Blood and Liquid Reagent

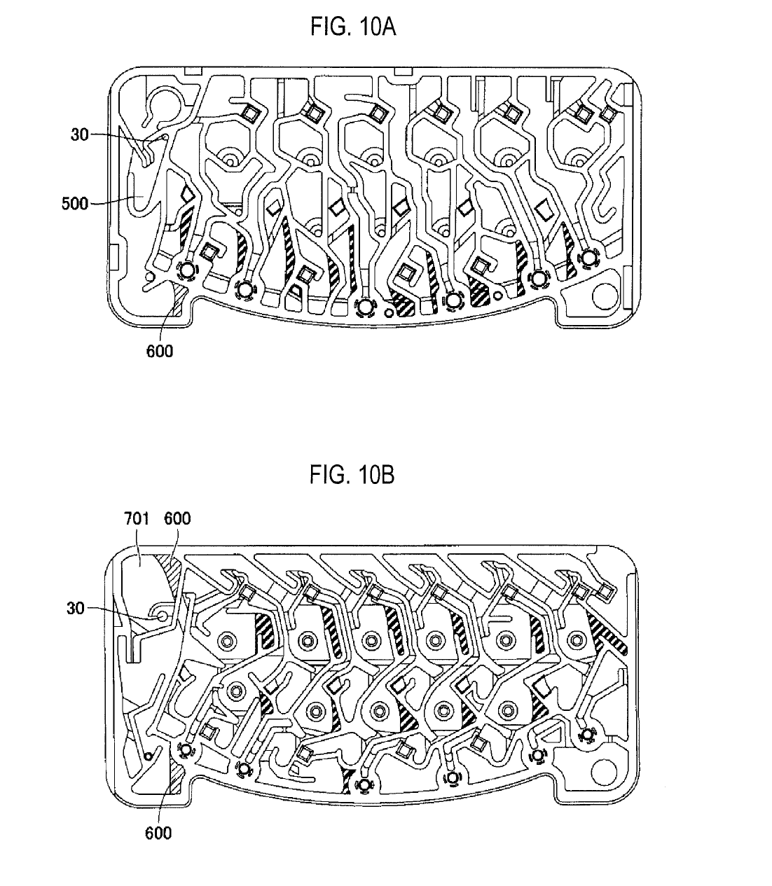

First, in this process in FIGS. 9A and 9B, a centrifugal force is applied to the microchip as shown in FIGS. 5 and 6 downward (hereinafter simply referred to as downward, this is equally applied to FIGS. 10A to 17B and other directions). With the centrifugal force is applied, the whole blood 600 introduced from the specimen introduction hole 120 (see FIG. 4) of the first substrate 101 is introduced into the specimen measurement unit 500 and measured. The whole blood 600 spilled over out of the specimen measurement unit 500 is accommodated in the spillage container 330a (see FIG. 9A). In addition, under this downward centrifugal force application, liquid reagents within the liquid reagent containers 301a and 301b reach the reagent measurement units 411a and 411b through the channels (through-holes) 21b and 21c, respectively, and are measured therein (see FIG. 9B). Liquid reagents spilled over out of the liquid reagent measurement units are accommodated in the spillage reagent containers 331a and 331b within the upper fluid circuit through the channels (through-holes) 21a and 21d, respectively (see FIG. 9A). In this step, if there is no abnormality in the amount of liquid reagent, liquid reagents are present in all the spillage reagent containers except the spillage reagent container 332b.

(2) Movement Process of Whole Blood

Next, a right centrifugal force is applied to the whole blood 600. This allows the whole blood 600 measured in the specimen measurement unit 500 to be moved to a waiting unit 701 of the lower fluid circuit through a through-hole 30 (see FIG. 10B).

(3) Separation Process of Blood Cell

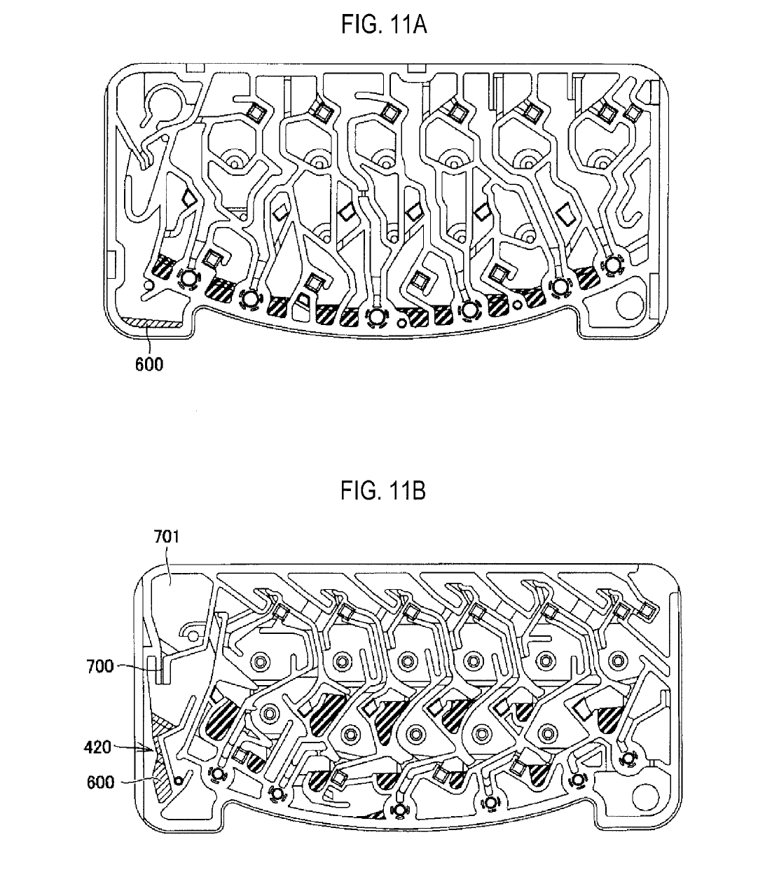

Next, a downward centrifugal force is applied to the whole blood 600. This allows the total amount of measured whole blood 600 in the waiting unit 701 to be introduced into the separator 420 through the flow rate restrictor 700 (see FIG. 11B). The whole blood 600 introduced into the separator 420 is centrifugally separated into a blood plasma ingredient (upper layer) and a blood cell ingredient (lower layer) in the separator 420. Each liquid reagent is again accommodated in the respective reagent measurement unit.

(4) Measurement Process of Plasma Ingredient

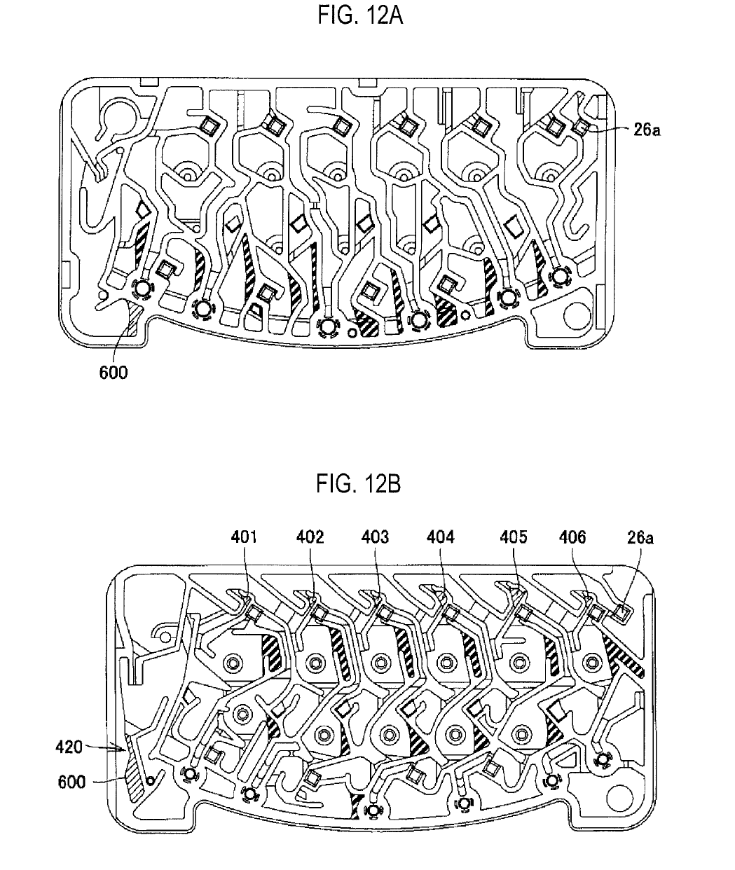

Next, a right centrifugal force is applied to the blood plasma ingredient. This allows the blood plasma ingredient separated in the separator 420 to be introduced into the ingredient measurement unit 401 (simultaneously introduced into the ingredient measurement units 402, 403, 404, 405 and 406) and to be measured therein (see FIG. 12B). Blood plasma ingredients spilled over out of the ingredient measurement units are moved into the upper fluid circuit through the channel (through-hole) 26a (see FIG. 12A).

(5) First Mixing Process

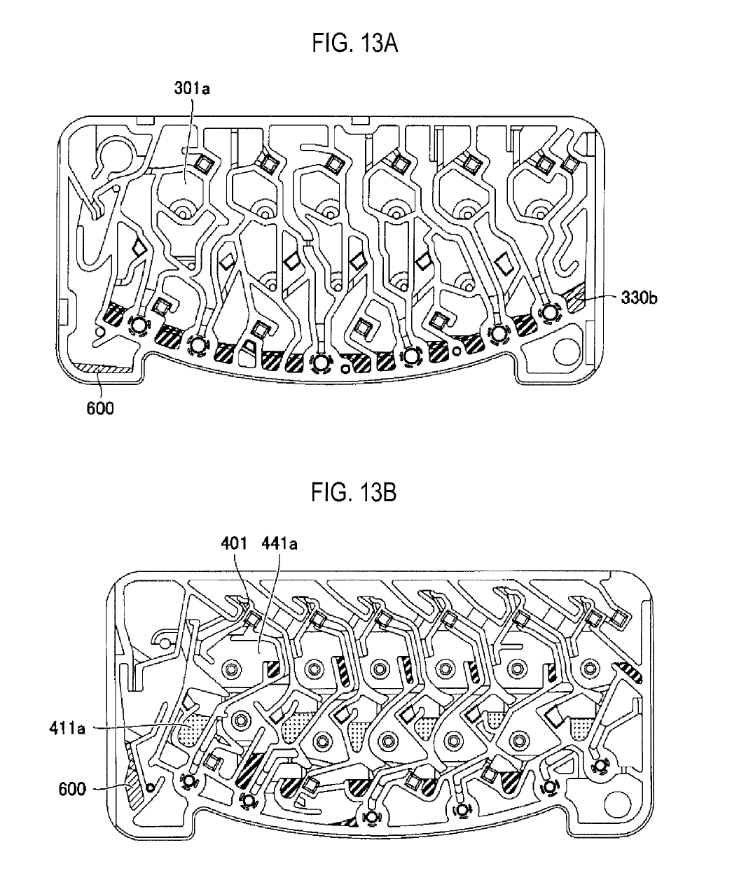

Next, a downward centrifugal force is applied to the liquid reagent and the blood plasma. This allows the measured liquid reagent (the liquid reagent accommodated in the reagent container 301a) and the blood plasma ingredient measured in the ingredient measurement unit 401 to be mixed together in the reagent measurement unit 411a (a first step of the first mixing process, see FIG. 13B). In this case, a liquid reagent remains in the mixer 441a of the lower fluid circuit.

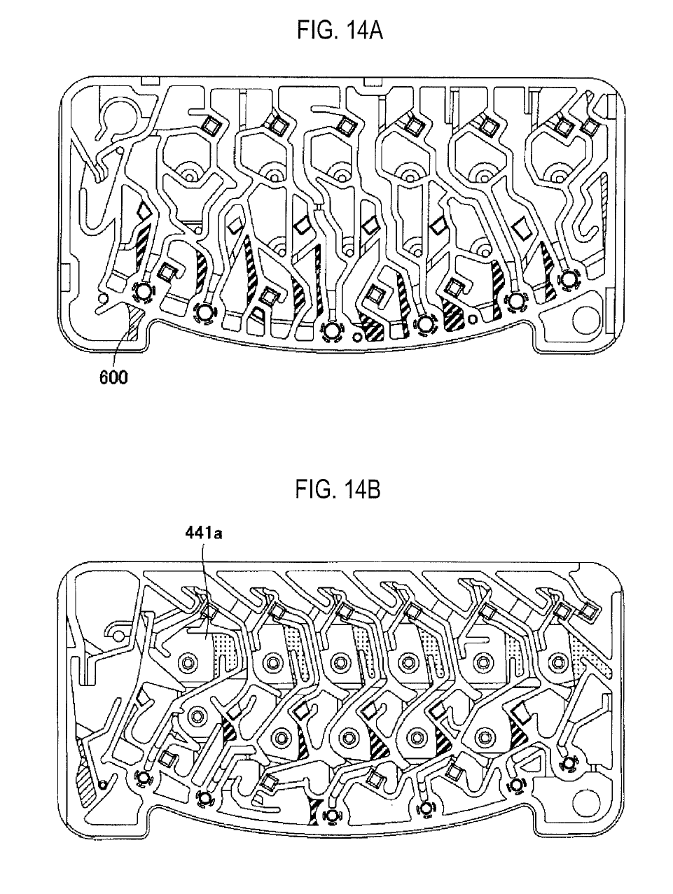

Next, a right centrifugal force is applied such that the mixed solution is again mixed with the liquid reagent remaining in the mixer 441a (a second step of the first mixing process, see FIG. 14B). These first and second steps are performed several times as necessary to achieve a reliable mixture. Finally, the same state as that shown in FIGS. 14A and 14B is obtained.

(6) Second Mixing Process

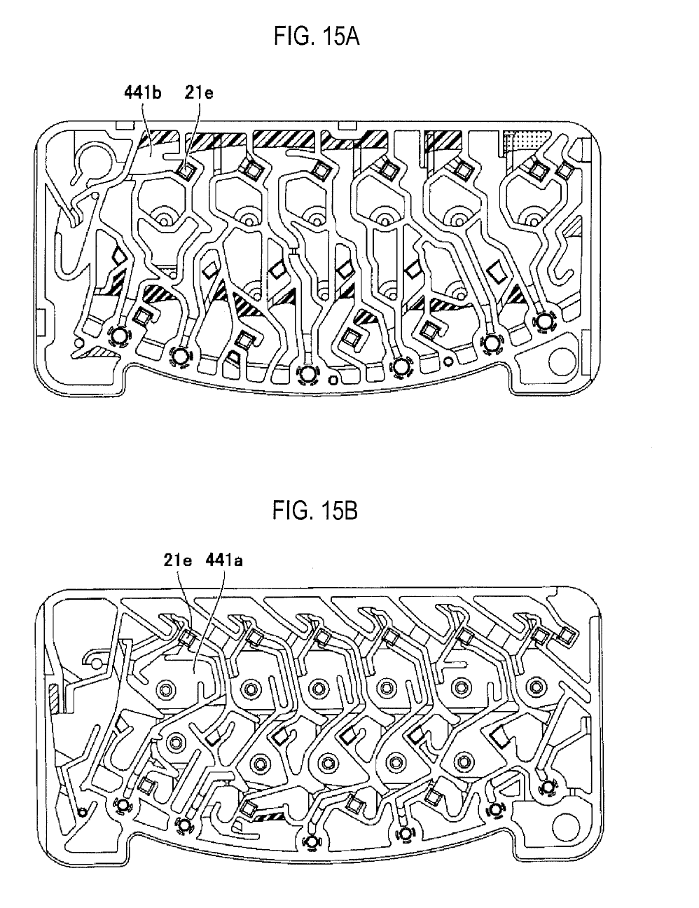

Next, an upward centrifugal force is applied to the mixed solution. This allows the mixed solution within the mixer 441a and one measured liquid reagent (the liquid reagent accommodated in the reagent container 301b) to reach the mixer 441b of the upper fluid circuit through the channel (through-hole) 21e and to be mixed together therein (a first step of the second mixing process, see FIGS. 15A and 15B).

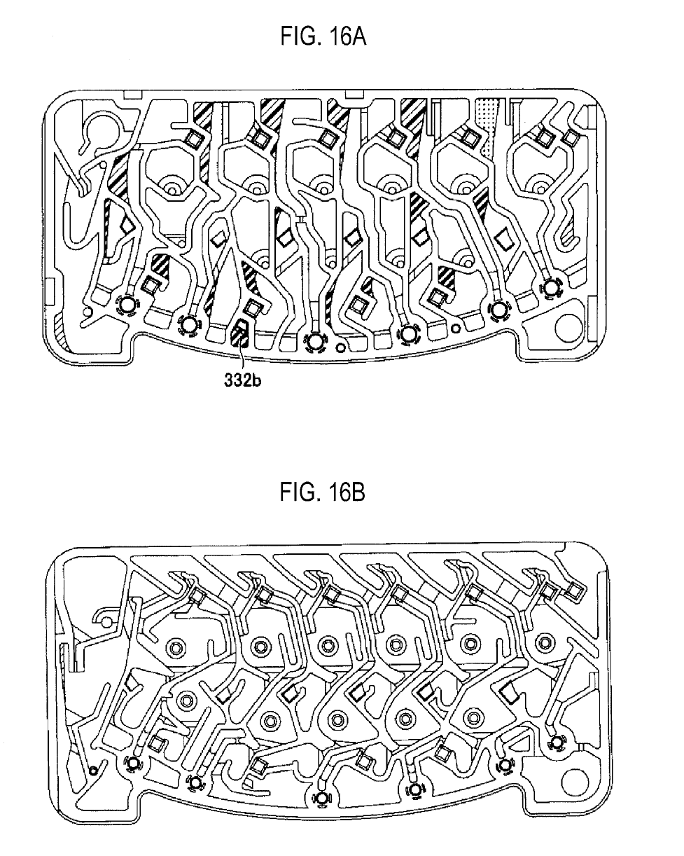

Next, as shown in FIG. 16A, a left centrifugal force is applied such that the mixed solution is moved to accelerate the mixture (a second step of the second mixing process, see FIG. 16A). In addition, this left centrifugal force allows the liquid reagent to be accommodated in the spillage reagent container 332b (see FIG. 16A). These first and second steps are performed several times as necessary to achieve a reliable mixture. Finally, the same state as that shown in FIGS. 16A and 16B is obtained.

(7) Detector Introduction Process

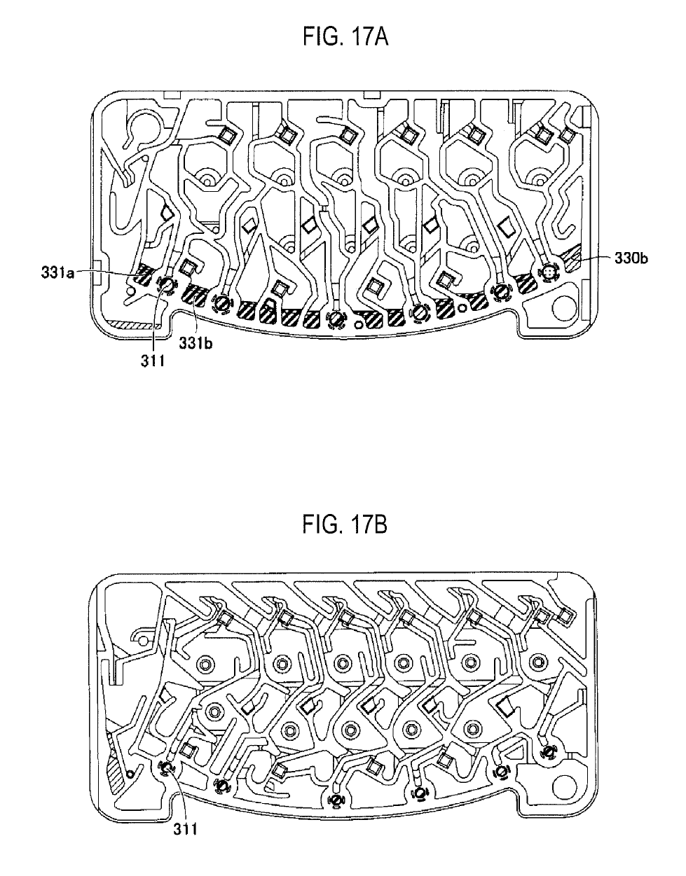

Finally, a downward centrifugal force is applied to the mixed solution. This allows the mixed solution to be introduced into the detector 311 (this is equally applied to other mixed solutions. See FIGS. 17A and 17B.). In addition, the liquid reagent or the blood plasma ingredient is accommodated in the spillage reagent containers 331a and 331b and the spillage container 330b. This is equally applied to other spillage reagent containers. The mixed solution filled in the detector is provided for optical measurement for examination and analysis. For example, detection of a particular ingredient in the mixed solution is achieved by irradiating a surface of the microchip with light in a direction substantially perpendicular to the microchip surface and measuring transmitted light. In addition, in this case, the presence of blood plasma ingredient and liquid reagent is checked by irradiating the spillage container 330b and each spillage reagent container with light and measuring intensity of reflected light. Although the presence of blood plasma ingredient and liquid reagent is not necessarily checked in this step, since the plasma ingredient and the liquid reagent can be accommodated in all of the spillage containers and the spillage containers in this step, the presence of plasma ingredient and liquid reagent may be checked after the detector introduction process for the purpose of simple operation.

### Second Embodiment

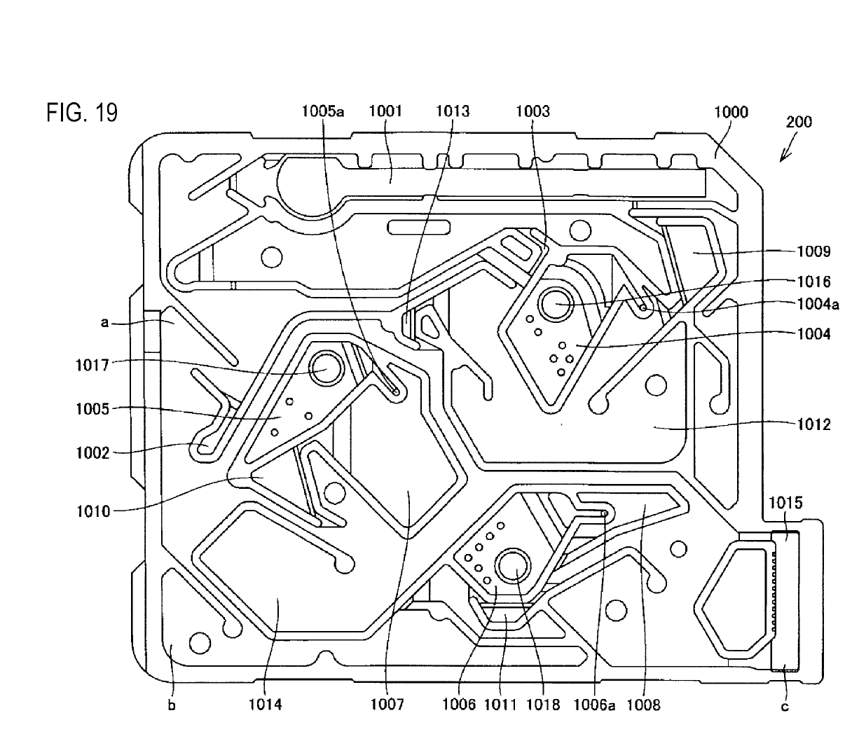

FIG. 19 is a top view illustrating another example of the microchip of the present disclosure. A microchip 200 shown in FIG. 19 is a microchip which includes a single-layered fluid circuit formed by stacking a second substrate (not shown in FIG. 19) on a first substrate 1000 having grooves formed on its surface. The first substrate 1000 is bonded on the second substrate (not shown) such that a groove forming surface of the first substrate 100 faces the second substrate. In FIG. 19, a surface in the opposite side to the groove forming surface of the first substrate 1000 is indicated by a solid line for the purpose of convenience of description. In the microchip 200, the second substrate is the same as the first substrate 1000 or has the same contour as the first substrate 1000. Each of the first substrate 1000 and the second substrate is a transparent substrate or a black substrate made of, for example, thermoplastic resin.

The microchip 200 mainly includes a sample tube mounting unit 1001, a separator 1002, a blood cell measurement unit 1003, three reagent containers 1004, 1005 and 1006, reagent container 1007 and 1008, three reagent measurement units 1009, 1010 and 1011, a first mixer 1012, a mixed solution measurement unit 1013, a second mixer 1014 and a detector 1015. The sample tube mounting unit 1001 is configured to assemble a sample tube, such as a capillary, containing whole blood collected from a subject. The separator 1002 is configured to separate the whole blood drawn from the sample tube into a blood cell ingredient and a blood plasma ingredient. The blood cell measurement unit 1003 is configured to measure the separated blood cell ingredient. Three reagent containers 1004, 1005 and 1006 are configured to accommodate liquid reagents. The reagent container 1007 and 1008 are disposed adjacent to the reagent containers 1005 and 1006, respectively, for temporarily receiving the liquid reagents. The three reagent measurement units 1009, 1010 and 1011 are configured to measure the liquid reagents. The first mixer 1012 is configured to mix the blood cell ingredient and the liquid reagents. The mixed solution measurement unit 1013 is configured to measure a mixed solution of the blood cell ingredient and the liquid reagents. The second mixer 1014 is configured to mix the mixed solution of the blood cell ingredient and the liquid reagents and other liquid reagents. The detector 1015 is configured to examine and analyze a resultant mixed solution.

The three reagent containers 1004, 1005 and 1006 have the respective reagent introduction holes 1016, 1017 and 1018 for injecting the liquid reagents into the reagent containers. The reagent introduction holes 1016, 1017 and 1018 are through-holes which penetrate through the first substrate 1000 in its thickness direction. For practical use, the microchip 200 of this embodiment is typically offered with the reagent introduction holes 1016, 1017 and 1018 sealed by a sealing label, etc., after injection of a liquid reagent from the reagent introduction holes 1016, 1017 and 1018. In the following description, the liquid reagents injected into and accommodated in the reagent containers 1004, 1005 and 1006 through the reagent introduction holes are referred to as “liquid reagents R0, R1 and R2,” respectively.

As described above, the fluid circuit of the microchip 200 of this embodiment is adapted to sequentially mix the liquid reagents R0, R1 and R2 with the blood cell ingredient separated from the whole blood and perform examination and analysis, including optical measurement and so on, for an obtained mixed solution.

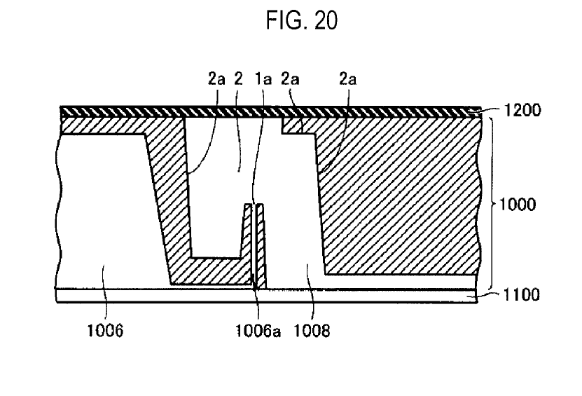

In this embodiment, the microchip 200 has the above-described characteristics for the structure of the reagent containers and their vicinity. The reagent container 1006 will be described below by way of example. FIG. 20 is a schematic sectional view illustrating a structure of the reagent container 1006 and its vicinity. This sectional view shows both a second substrate 1100 stacked on the first substrate 1000 and a sealing label 1200 for sealing openings such as the reagent introduction holes.

As shown in FIG. 20, the reagent container 1006 includes a channel 1006a which has one end (second end) connected to the reagent container 1006 and penetrates through the first substrate 1000 in its thickness direction to guide the liquid reagent within the reagent container 1006 to the reagent container 1008 (Likely, as shown in FIG. 19, the reagent containers 1004 and 1005 include channels 1004a and 1005a which penetrate through the first substrate 1000 in its thickness direction, respectively). The channel 1006a corresponds to the above-described first channel. The channel 1006a is arranged such that its other end corresponding to the first end 1a (the discharge hole of the liquid reagent) is spaced apart from (i.e., makes no contact with) the inner wall 2a of the second channel 2 (including the reagent container 1008). This arrangement can prevent the liquid reagent reaching the first end 1a from leaking into the second channel 2.

An example of fluid treatment using the microchip 200 shown in FIG. 19 will be described below. First, a sample tube which collected a whole blood sample is inserted in the sample tube mounting unit 1001. Next, the whole blood sample is extracted from the sample tube by applying a centrifugal force to the microchip in a direction toward the left side in FIG. 19 (hereinafter simply referred to as the left direction, this is equally applied to other directions) and the blood plasma ingredient is separated from the blood cell ingredient by introducing the whole blood sample into the separator 1002 and performing centrifugal separation for the whole blood sample using a centrifugal force in the downward direction. Next, an upper plasma ingredient is removed by a centrifugal force in the left direction. The removed plasma ingredient is received in a region a. Subsequently, a centrifugal force is applied in the downward direction to adjust a liquid level of the blood cell ingredient within the separator 1002 while moving the removed plasma ingredient to a region b. Next, a centrifugal force is applied in the proper direction to introduce the liquid reagent R0 from the reagent container 1004 into the reagent measurement unit 1009 for measurement. This centrifugal force causes the liquid reagent R1 in the reagent container 1005 and the liquid reagent R2 in the reagent container 1006 to be moved to the reagent containers 1007 and 1008, respectively. In addition, this centrifugal force causes the blood cell ingredient in the separator 1002 to be introduced into the blood cell measurement unit 1003 for measurement.

Next, a centrifugal force is applied in the downward direction to obtain a mixed solution by mixing the measured blood cell ingredient and the liquid reagent R0 in the first mixer 1012. This centrifugal force causes the liquid reagent R2 in the reagent container 1008 to be measured by the reagent measurement unit 1011. Subsequently, centrifugal forces are sequentially applied to the right, downward, left and downward directions to obtain a sufficient mixture of the mixed solution. In addition, a centrifugal force is applied in the left direction to allow the reagent measurement unit 1010 to measure the liquid reagent R1 in the reagent container 1007. Next, a centrifugal force is applied in the downward direction to move the measured liquid reagent R1 to the second mixer 1014.

Next, after a centrifugal force is applied in the left direction, centrifugal forces are sequentially applied in the left upward direction and the left direction to introduce an upper clear portion of the mixed solution in the first mixer 1012 into the mixed solution measurement unit 1013 for measurement. Next, a centrifugal force is applied in the downward direction to allow the second mixer 1014 to mix the measured solution and the liquid reagent R1. Subsequently, centrifugal forces are sequentially applied in the left and downward directions to obtain a sufficient mixture of the mixed solution. Under the application of the centrifugal force in the downward direction, the measured liquid reagent R2 is located in a region c. Next, a centrifugal force is applied in the right direction to allow the detector 1015 to mix the mixed solution and the liquid reagent R2 and a centrifugal force is applied in the downward direction to obtain a sufficient mixture. Finally, a centrifugal force is applied in the right direction to cause the mixed solution to be received in the detector 1015, which is then irradiated with light for measurement of optical properties such as the intensity of transmitting light.

### Third Embodiment

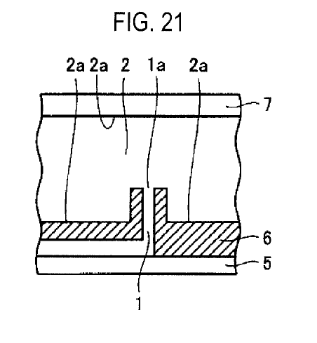

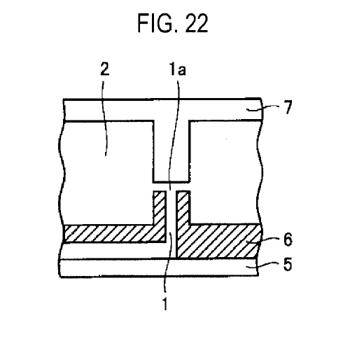

FIGS. 21 and 22 are sectional views schematically illustrating another example of the microchip of the present disclosure. In these figures, a portion where the first and second channels 1 and 2 according to the present disclosure are formed is enlarged. Like the first embodiment, a microchip shown in FIGS. 21 and 22 has a stacked structure of a first substrate 7, a second substrate 6 and a third substrate 5 and includes a two-layered fluid circuit. As shown in FIG. 22, grooves constituting the fluid circuit may be formed in not only the second substrate 6 but also the first and third substrates 7 and 5 with the second substrate 6 interposed therebetween as long as a first end la is spaced apart from (makes no contact with) an inner wall 2a of the second channel 2. Also in a microchip including a single-layered fluid circuit as in the second embodiment, grooves may be formed in the other substrate.

### Fourth Embodiment

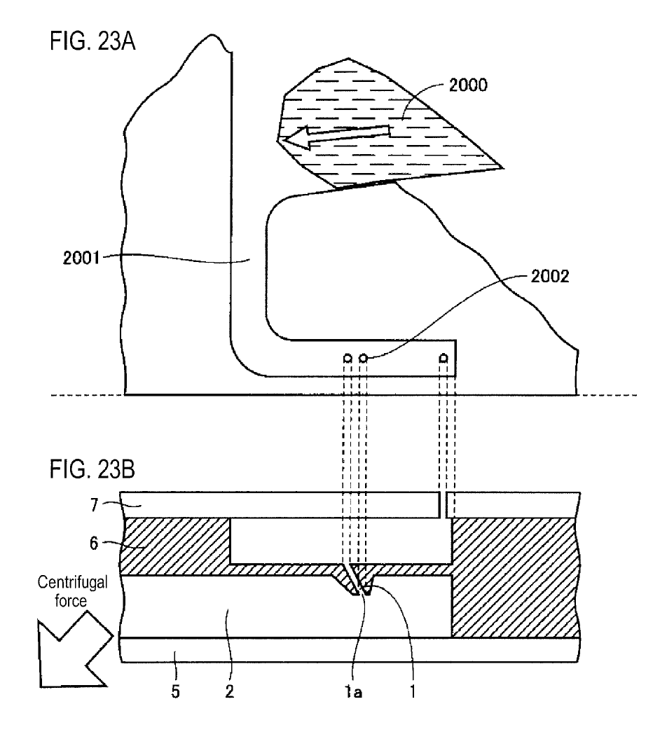

The present disclosure is not limited to the above-described characteristics for the structure of the reagent container and its vicinity. For example, the above-described characteristics may be provided to various measurement units and their vicinity, such as the ingredient measurement unit for measuring the blood plasma ingredient separated from the whole blood as shown in FIGS. 23A and 23B. FIGS. 23A to 25B are a top view and a sectional view schematically illustrating another example of the microchip of the present disclosure. In these figures, an ingredient measurement unit for measuring a plasma ingredient and its vicinity are shown in enlargement. In FIGS. 23A to 25B, A is a top view and B is a sectional view. As used herein, the top view refers to a top view of the second substrate 6 formed with grooves constituting a fluid circuit.

A microchip shown in FIGS. 23A and 23B has a stacked structure of a first substrate 7, a second substrate 6 and a third substrate 5 and includes a two-layered fluid circuit. As shown, an upper fluid circuit includes an ingredient measurement unit 2001 for measuring a blood plasma ingredient 2000 separated by a separator (not shown). Openings 2002 are formed on the bottom of the ingredient measurement unit 2001 and the first channel 1 penetrating through the second substrate 6 in its thickness direction are connected to the openings 2002. The first channel 1 is a channel for guiding a plasma ingredient spilled over in measurement to a waste solution tank (not shown) within a lower fluid circuit. The first channel 1 is arranged such that its other end corresponding to the first end 1a (the discharge hole of the spillage of blood plasma ingredient to the second channel) is spaced apart from (i.e., makes no contact with) the inner wall of the second channel 2 of the lower fluid circuit. This arrangement can prevent the measured blood plasma ingredient from leaking into the second channel 2 due to surface tension, which may result in a high precision measurement.

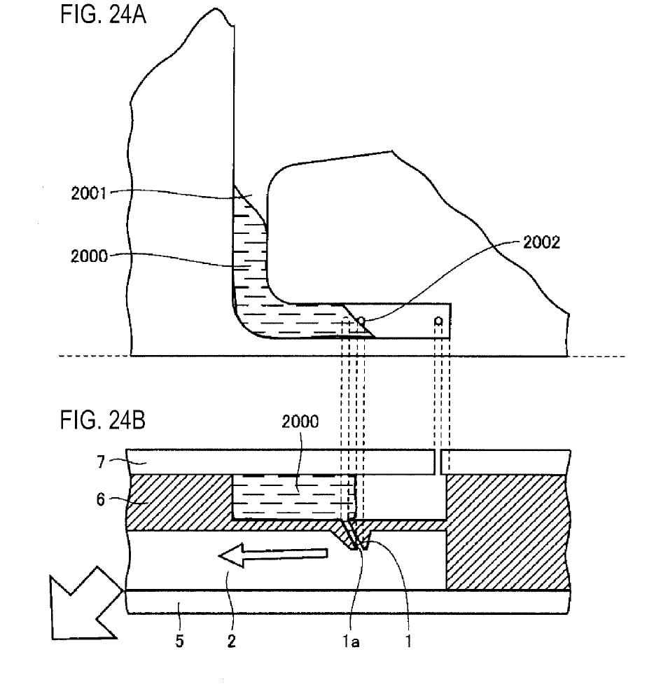

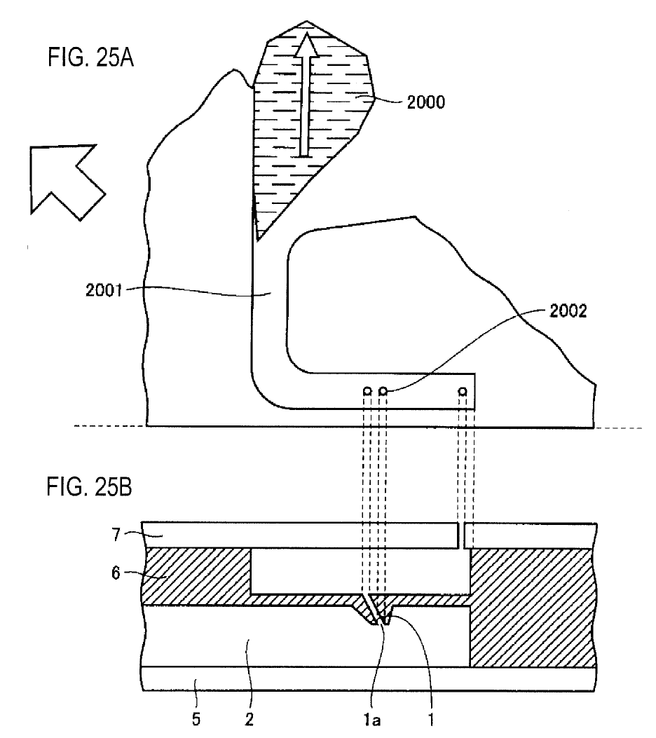

An example of a measurement of a blood plasma ingredient using the microchip shown in FIGS. 23A and 23B will be described with reference to FIGS. 23A to 25B. First, by applying a centrifugal force in a direction indicated by an arrow in FIG. 23A, the blood plasma ingredient 2000 separated by the separator (not shown) is introduced into the ingredient measurement unit 2001 (a plasma introduction process, see FIGS. 23A and 23B) and the ingredient measurement unit 2001 is filled with the blood plasma ingredient 2000 to measure the plasma ingredient (a plasma measurement process, see FIGS. 24A and 24B). In the blood plasma measurement process, an excessive blood plasma ingredient 2000 exceeding a capacity of the ingredient measurement unit 2001 is received in the waste solution tank (not shown) of the lower fluid circuit through the first channel 1 and then the second channel 2. Since the first and second channels 1 and 2 have a structure according to the present disclosure, the measured plasma ingredient will not leak into the second channel 2 due to surface tension when the application of centrifugal force is stopped after the plasma measurement process. Finally, by applying a centrifugal force in a direction indicated by an arrow in FIG. 25A, the measured blood plasma ingredient is discharged out of the ingredient measurement unit 2001 (a blood plasma discharge process, see FIGS. 25A and 25B). The discharged plasma ingredient is provided for mixture with a liquid reagent.

According to the present disclosure in some embodiments, it is possible to provide a microchip which is capable of moving a liquid present in a fluid circuit to a desired position within the fluid circuit by application of a centrifugal force, thereby preventing unintended movement of the liquid due to surface tension.

While certain embodiments have been described, these embodiments have been presented by way of example only, and are not intended to limit the scope of the disclosures. Indeed, the novel embodiments described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A microchip, comprising,
a fluid circuit defined by a space formed in the microchip, wherein a liquid present in the fluid circuit is moved to a desired position in the fluid circuit,
wherein the fluid circuit includes
a first channel passing the liquid, and
a second channel passing the liquid passed through the first channel,
wherein the first channel includes a first end at an end of the second channel, the first end being spaced apart from an inner wall of the second channel.

2. The microchip of claim 1, wherein the fluid circuit includes a reagent container which accommodates a liquid reagent, and
wherein the reagent container includes a discharge hole for discharging the liquid reagent in the first end out of the reagent container.

3. The microchip of claim 1, wherein the first end of the first channel is arranged to be located within the second channel.

4. The microchip of claim 1, wherein a sectional area of the first channel is smaller than a sectional area of the second channel.
